(19) United States
(12) Patent Application Publication
(10) Pub. No.: US 2002/0077940 A1
(43) Pub. Date: Jun. 20, 2002

(54) Method and apparatus for creation and transmission of financial statement data

(76) Inventor: Travis C. Riley, Beaumont, TX (US)

Correspondence Address: William C. Norvell, Jr., BEIRNE, MAYNARD & PARSONS, L.L.P., Suite 2500, 1300 Post Oak Boulevard, Houston, TX, 77056-3000, US

(21) Appl. No.: 09/745,262

(22) Filed: Dec. 20, 2000

(51) Int. Cl. G06F 17/60

(52) U.S. Cl. 705/30

(57) ABSTRACT

A method, system and article of manufacture incorporates a financial institution computer system for extracting financial data within a data base, formatting the data and transmitting the formatted data via electronic mail. Electronic information on financial accounts of a customer is maintained within the data base in the financial institution computer system. The electronic information is processed to identify and extract pre-selected data and the processed data is electronically formatted for transmission to the customer via electronic mail to a location designated by the customer via electronic mail for storage within and readout on a computer system of the customer.

### BACKGROUND OF THE INVENTION

(1) Field of the Invention

The present invention is directed to a method, an article of manufacture, and a system incorporating a computer system of a financial institution, wherein data fields are provided and access thereto is initiated for the generation of financial information for format and transmission via electronic mail to the customer on an incremental time basis.

(2) Brief Description of the Prior Art

Electronic mail (or “e-mail”) is a popular way for people to communicate. Using e-mail, a person can send messages and other information such as formalized documents, etc., that are in digital form, either in the mail itself, or as an “attachment” in a rather lengthy e-mail configuration.

E-mail communication systems are generally regarded as multi-cast, store-and-forward bi-directional communication systems. A user can send e-mail messages to one or more recipients at a time. An e-mail system is regarded as bi-directional as, usually, a user can both send and receive e-mail messages. Uni-directional systems are also popular.

When using e-mail to communicate, a user will typically create a message using an e-mail program running on a computer that is or can be connected by a network to other computers. The message will include the e-mail address of the intended recipient. When the user has finished entering the message, the user will “send” the message to the intended recipient. The message is electronically transmitted via the computer network. The recipient, also using an e-mail program running on a computer connected to a computer network, can then read the received message.

A common computer network used to send and receive e-mail is the Internet. The Internet allows users to send and receive e-mail to and from computers around the world. Typically, each user will have an Internet e-mail address unique to that user, e.g., bob@pto.com. A user with an e-mail account and a computer that can connect to the Internet can easily send and receive e-mail over the Internet. Users connect to the Internet to send and receive e-mail through a number of on-line networks, such as America on Line, CompuServe, Microsoft Network, and the like. Using a computer with a modem, the user is supplied with a unique access number which is sourced through the network for sending and receiving e-mail.

In the past, banks and other similar financial organizations, have customarily sent out statements to customers on a given time basis, such as monthly. Generally speaking, separate accounts will generate statements which have been mailed to the customer. Recently, many banks and other financial institutions have offered statements in which all accounts are included in one statement, i.e., 2 or more checking accounts, a savings account, a line of credit, and the like.

Most banks offer a telephone “800” number for a customer to make specific inquiry regarding a debit, credit or balance for a particular account Most of the “800” numbers are automated and computer generated voice responses deliver the required messages and information to the customer upon the customer entering into the phone pad identification numbers for the account and other information. Often times, these “800” numbers are not satisfactorily responsive and result in delays in communicating the desired information to the customer, with the customer being placed on “hold” for many minutes.

The present invention addresses many of the problems described above by providing a method and system for sorting, generating and presenting banking and other financial data in a format from a host computer system, i.e., a host server, to a computer integrated into an e-mail system, preferably via the Internet as above described, for a very frequent transmission of the requested and desired information to the customer, such as on a daily basis, i.e., once each morning at a designated time. In this manner, the customer may be serviced with a “daily” or almost continuous data stream containing debit, credit and balance information on a host of accounts with the financial institution, such as a Bank, savings and loan association, or the like. The information is provided in a format which offers security to the customer with respect to proper identification of accounts and the like.

### DEFINITIONS

As used in the specification and the claims, the following words and phrases shall have the meanings corresponding thereto:

(1) “Checking Account”: a bank account against which the depositor can draw checks.

(2) “Savings Account”: an account (as in a bank) on which interest is usually paid and from which withdrawals can be made usually only by presentation of a passbook or by written authorization on a prescribed form.

(3) “Certificate of Deposit”: an account (as in a bank) on which interest is usually paid at an agreed upon rate for an specific, agreed upon, time period. For example, 7% for 90 day. Withdrawals of principle are usually not allowed (without penalty) during the term of the agreement.

(4) “Loan Account”: an account (as in a bank) reflecting money lent at interest.

(5) “Discount Loan Account”: an account (as in a bank) reflecting money lent at interest where the interest to be charged during the term on the loan is computed at the time the money is lent and added to the amount borrowed to determine the amount of the loan. The borrower receives as proceeds, the amount of the loan less the pre-computed interest (the discounted amount);

(6) “Simple Interest Loan Account”: an account (as in a bank) reflecting money lent at interest where interest charged is computed and added to the balance of the note on a daily basis using a daily interest rate factor.

(7) “Laser Notice File”: a data file containing customer notices (interest paid, NSF checks, payments due, etc.) formatted for printing on a laser printed.

(8) “NSF Check”: a check presented payment on an account against which the depositor can draw checks when there are not sufficient funds in the account to pay the check.

(9) “Predeterminable Time Increment Basis”: For example, daily at a set time each day.

(10) “Officer Order”: account information sorted in order of the initial of the bank officer assigned to the account (rather than in another order such as account number).

(11) CSV attachments: (comma separated values) information in a computer data file where each file record contains several data elements each separated by a comma. The comma marks the end of one data element and the beginning of another.

(12) Qwicken attachments: Information in a computer data file formatted to the requirements of the popular personal accounting program Quicken, for importing financial information into the program.

### SUMMARY OF THE INVENTION

The present invention provides a method, system and article of manufacture incorporating a financial institution computer system for extracting financial data within a data base in the computer system and for formatting the data and thereafter transmitting the formatted data via electronic mail. Electronic information is maintained on financial accounts of a customer within the data base in the financial institution computer system. The electronic information is processed within the data base to identify and extract pre-selected data therefrom. The data is electronically formatted for transmission to the customer via electronic mail. The formatted data is transmitted to a location designated by the customer via electronic mail for storage within and readout on a computer system of the customer.

The financial institution preferably is a bank. As used herein, the computer system may include a computer server, one or more personal computers and any other electronic computer system well known to those skilled in the art and utilized in financial institutions for the maintaining of electronic information pertaining to checking, savings, certificates of deposit, loan accounts, and the like. Electronic information is processed to identify and extract pre-selected data therefrom, such as mini trial balances for checking accounts, savings accounts, certificates of deposit, loan accounts, and discount loan accounts, simple interest loan accounts, and any and all other special service accounts of the financial institution for each of its customers. The information is electronically formatted such as by use of a “WINDOWS” type computer operating system including menu selections for customers, options, verify files, enable auto e-mail, generate e-mail, broadcast, help and exit.

A customer setup configuration is generated through sorting of the data field in the computer for each customer in at least one of the following fields sorted by file within the computer: account number; reference number; account name; account type; balance for designated accounts; transactions for designated accounts; non-sufficient funds designation; and day or date of report transmission.

### DESCRIPTION OF THE ILLUSTRATIONS

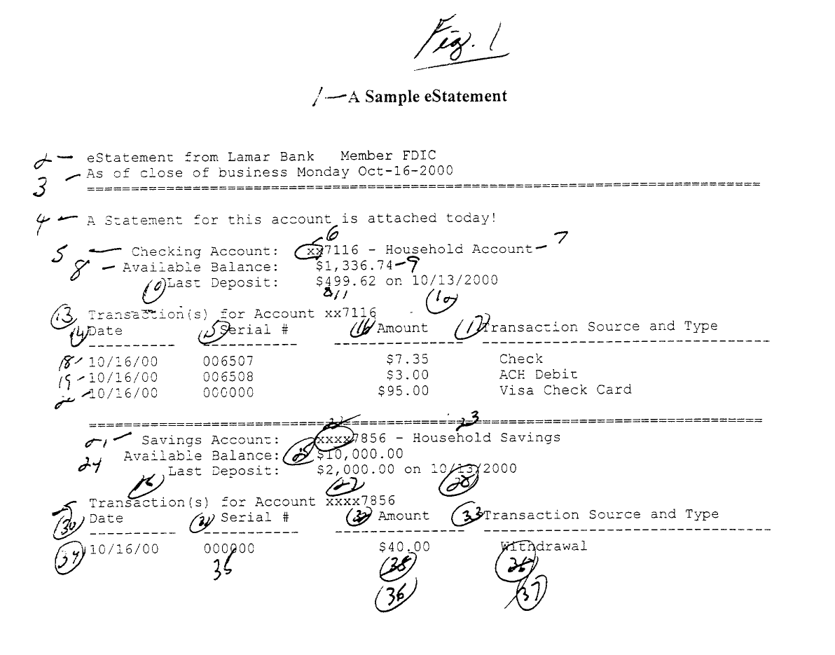

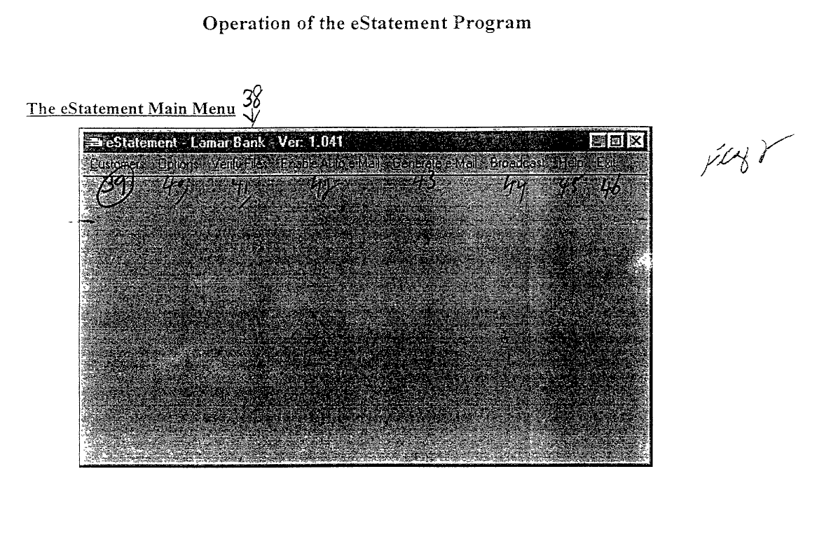

FIG. 1 is a printout of a sample or representative e-statement illustrating the preferred layout and configuration of the report generated in accordance with the present invention.

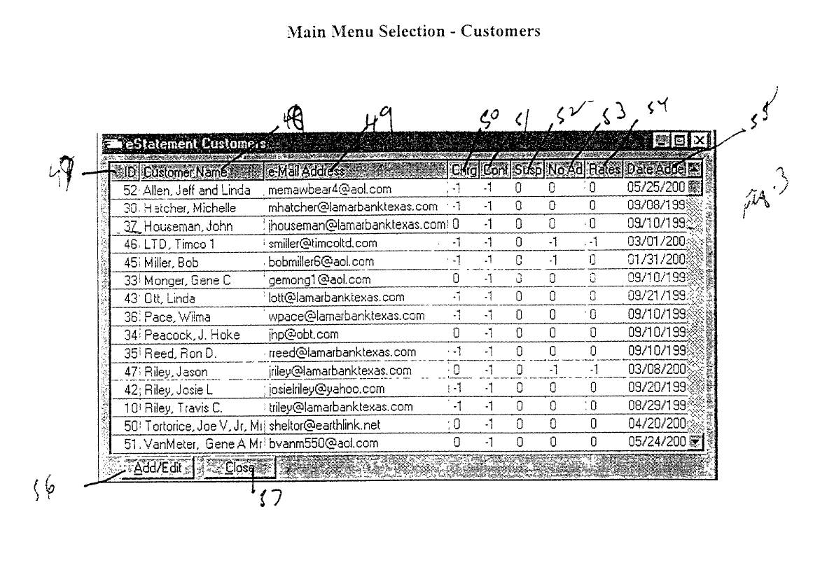

FIG. 2 is a view of the main menu for generating the e-mail report of the preferred embodiment of the invention in WINDOWS™ format as it would appear on a personal computer CRT or screen.

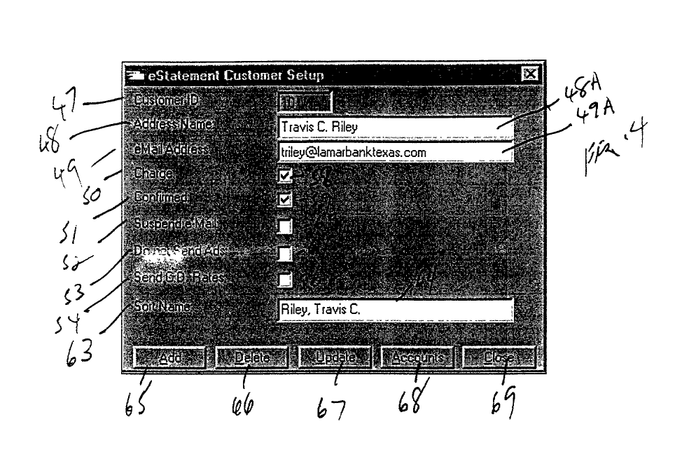

FIG. 3, similar to the illustration of FIG. 2, is an illustration of the customer's selection, 39, from the main menu.

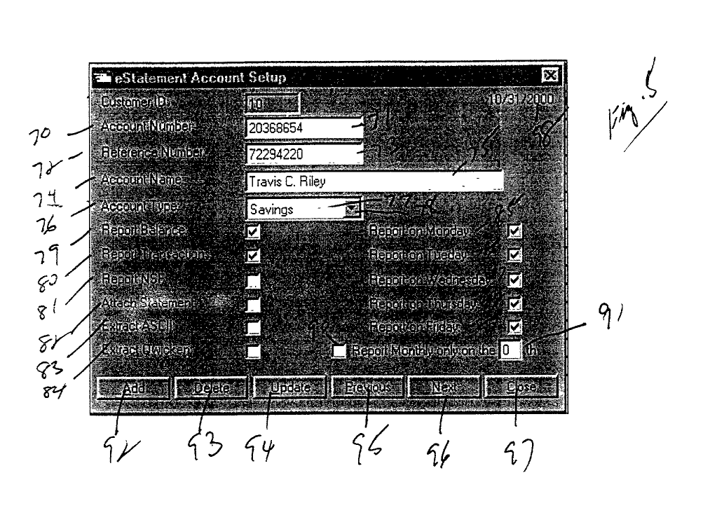

FIG. 4, is an illustration of the view of the customer set-up generated by selection at the add/edit button 56.

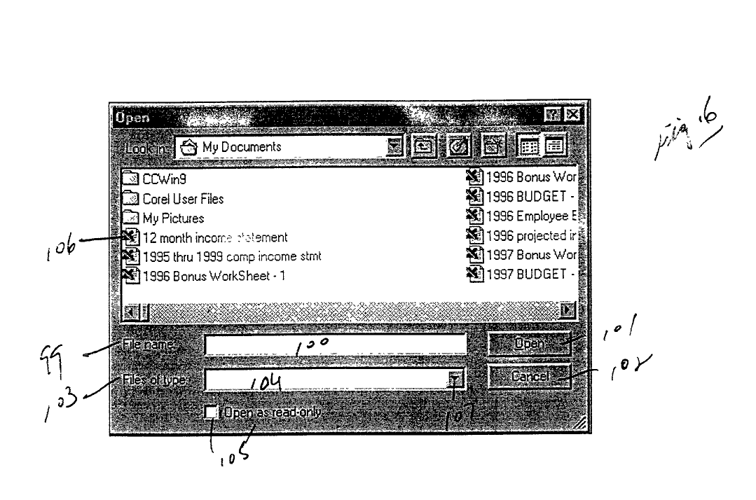

FIG. 5 is a view similar to that of FIG. 4 showing the customer account set up configuration which will appear by activating the accounts button 68 shown in FIG. 4.

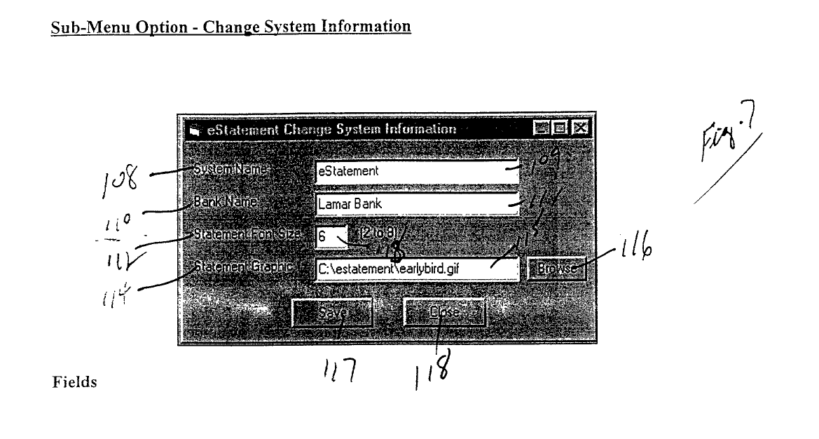

FIG. 6 is a view similar to the previous figures illustrating a sub-menu option of “change report path” and “change loan data path” by clicking onto the options field 40 illustrated in FIG. 2.

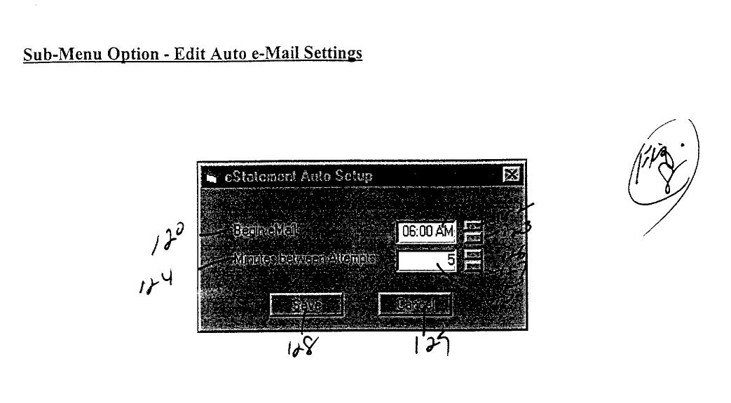

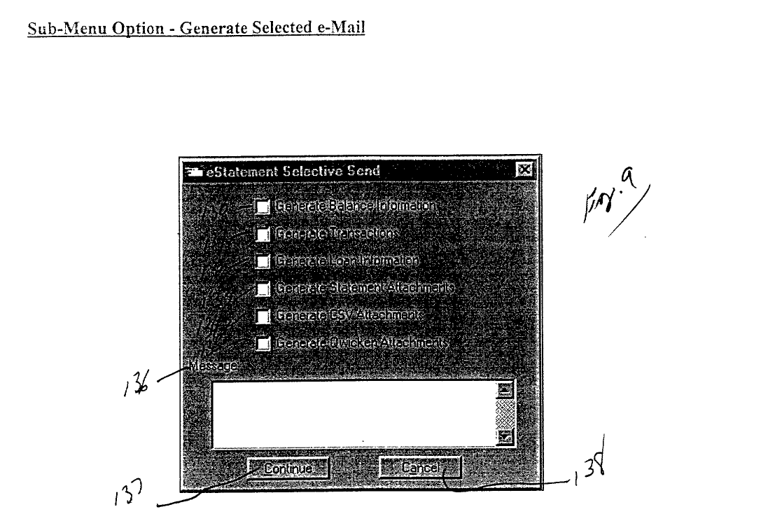

FIG. 7 is a view similar to the other figures of the sub-menu option for “change system information” resulting from scrolling at 107 in the sub-menu option illustrated in FIG. 6.

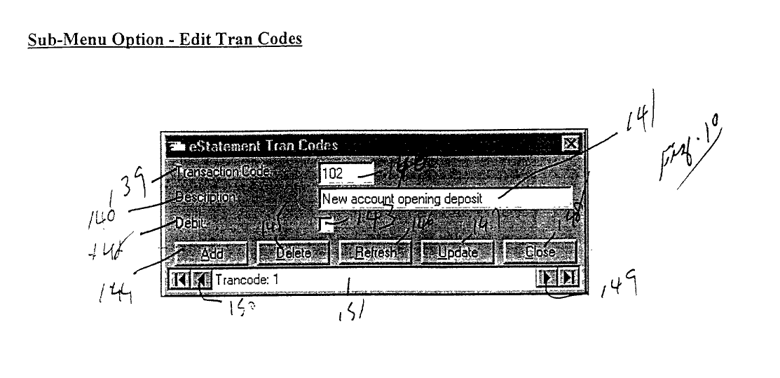

FIG. 8 is a view similar to the previous views of the sub-menu option of “Edit Auto E-Mail Settings” by scrolling at 107 in the sub-menu illustrated in FIG. 6.

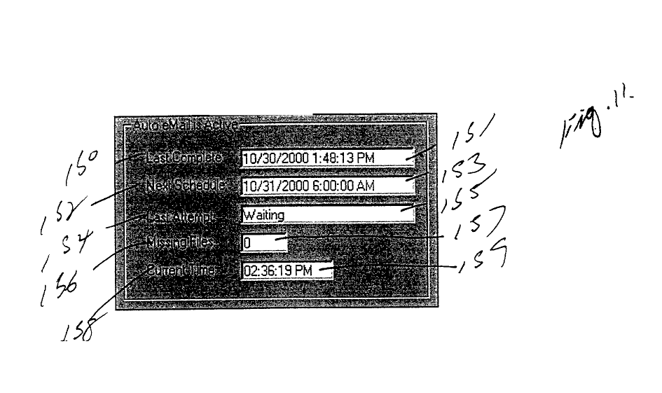

FIG. 9 is yet another sub-menu option which may be position by again scrolling at 107 on the sub-menu profile of FIG. 6.

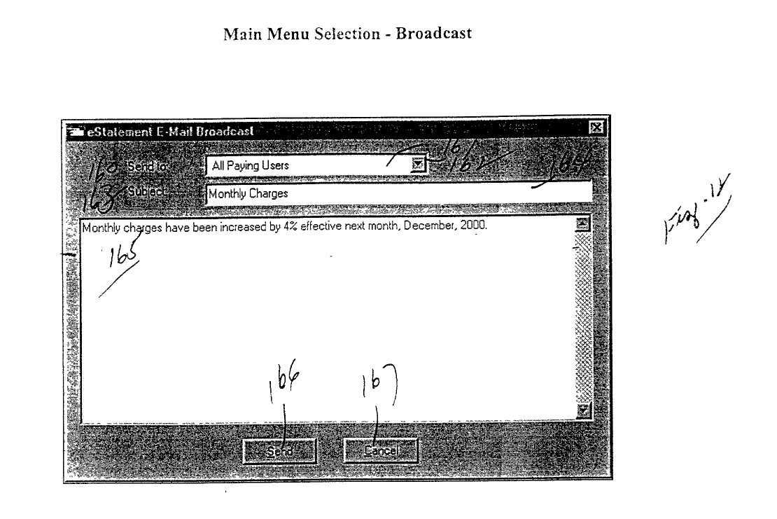

FIG. 10 is a view of yet another sub-menu option of “Edit Transaction Codes” which may be selected by again scrolling at 107.

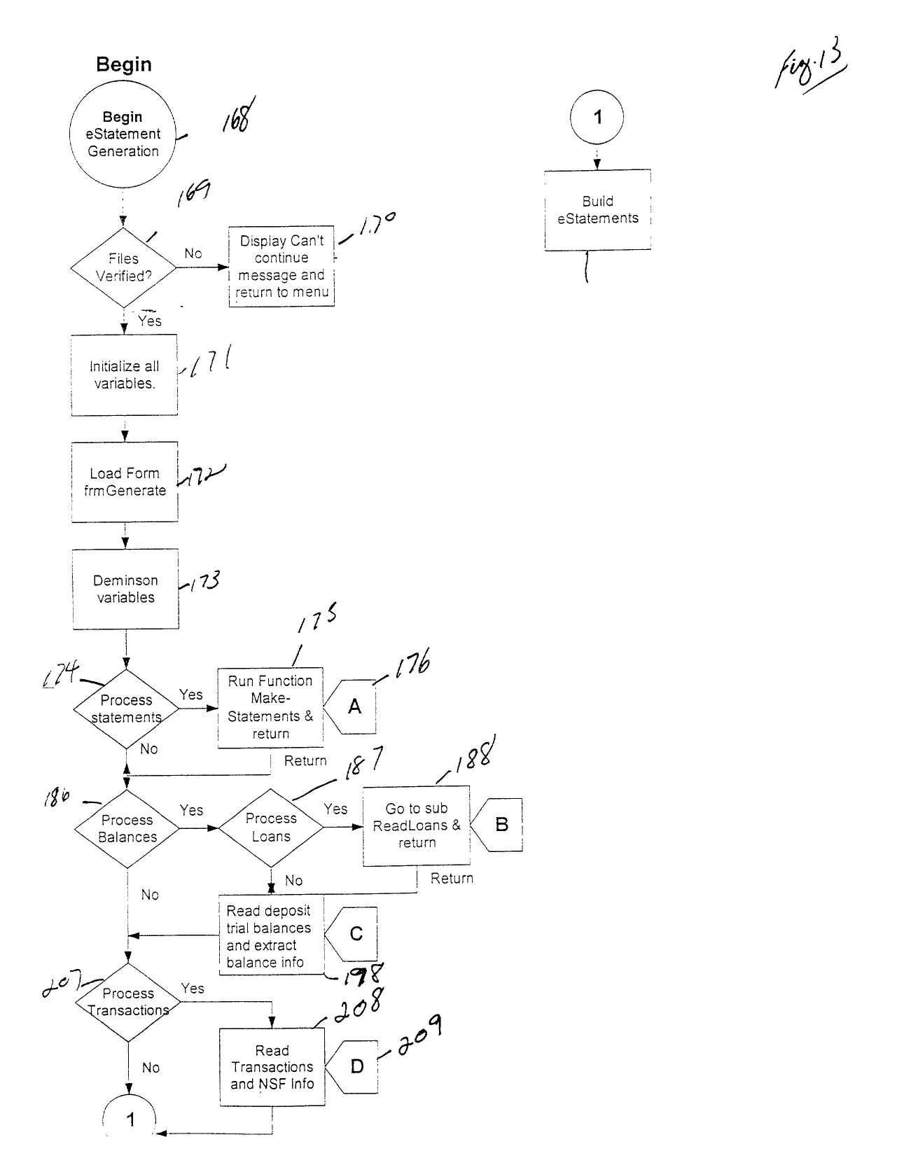

FIG. 11 is an illustration of the selection on the main menu of “enable auto e-mail” and “disable auto e-mail”, field 42 as illustrated in FIG. 2.

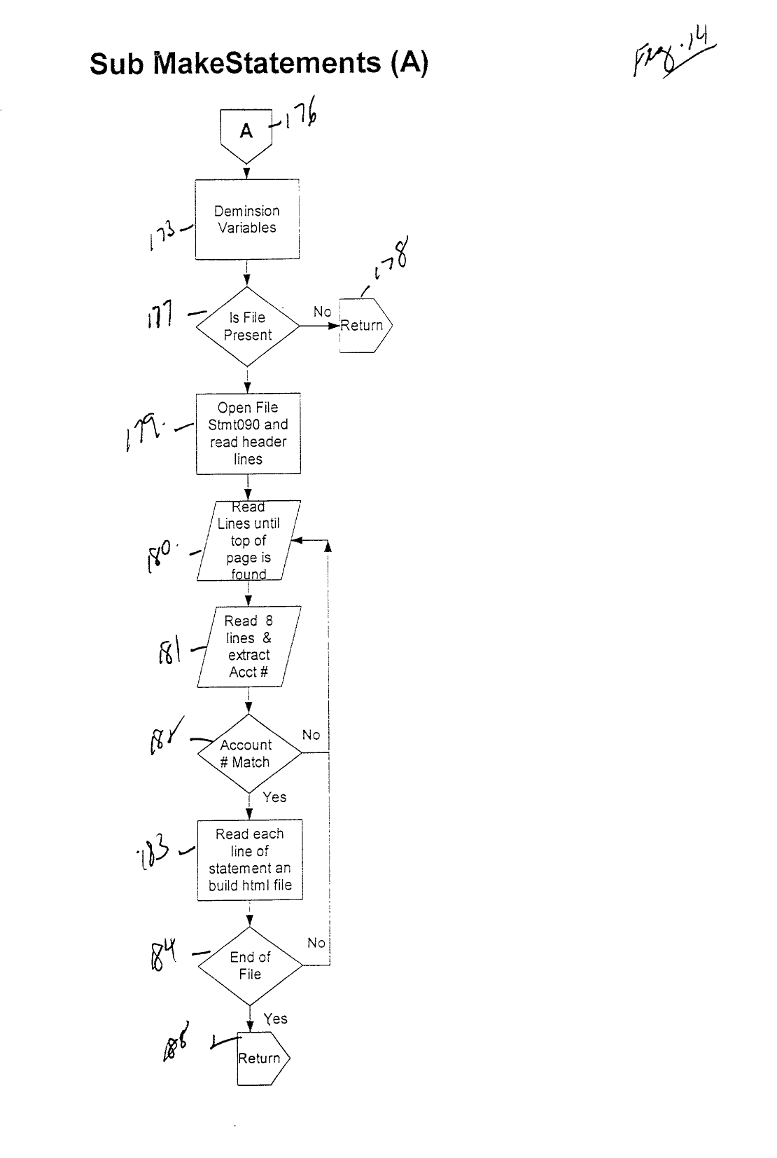

FIG. 12 is yet another illustration of another main menu selection in the “broadcast” field 44 of FIG. 2.

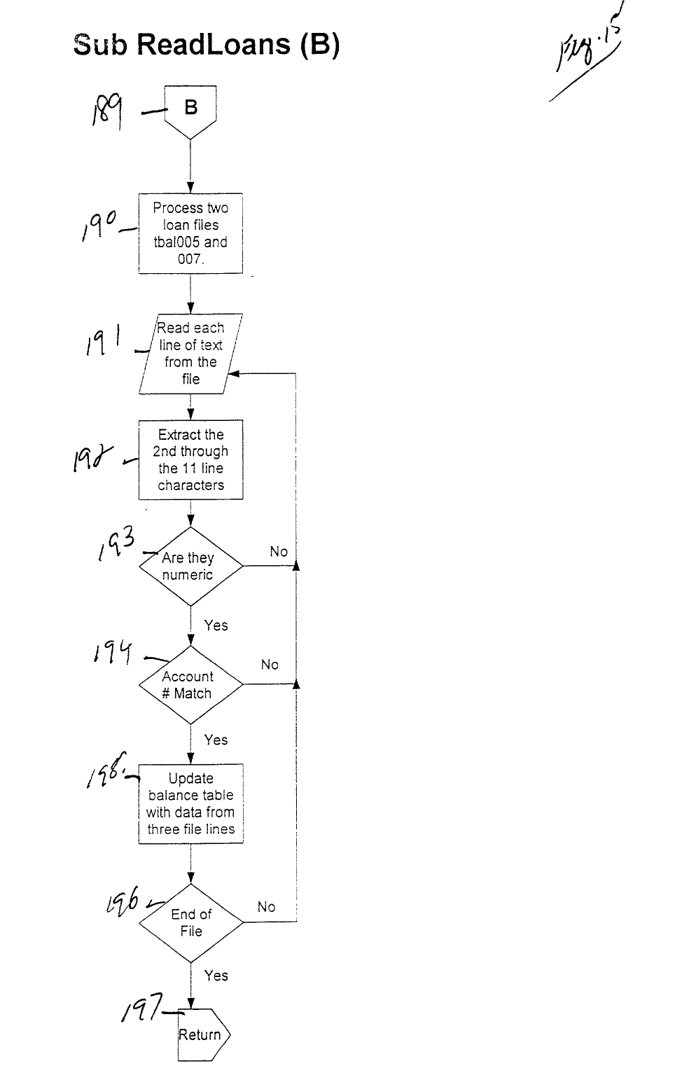

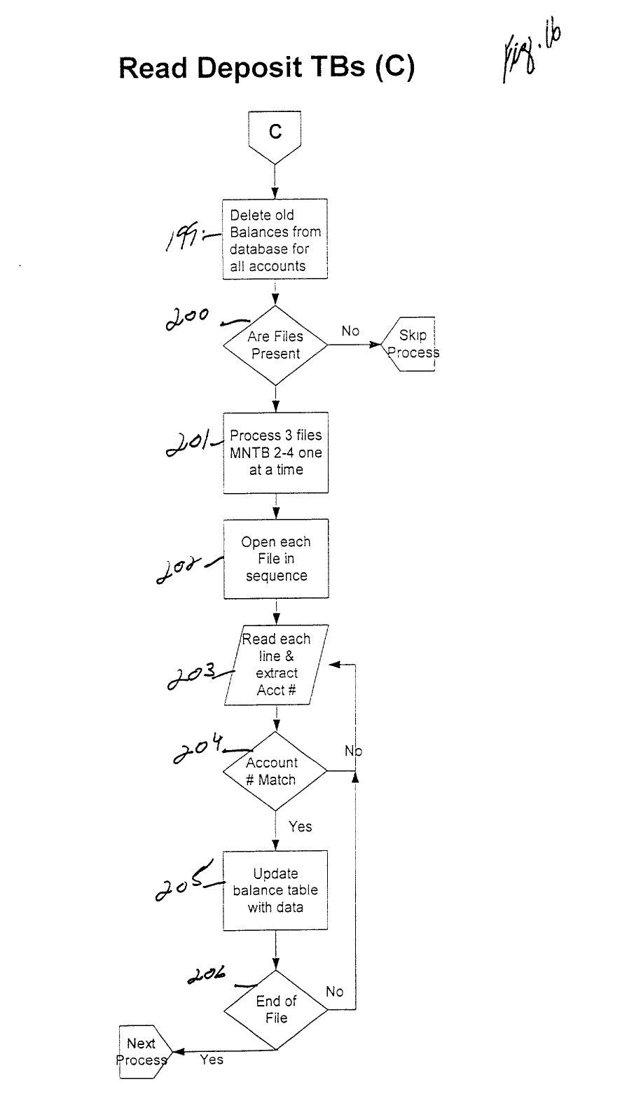

FIG. 13 illustrates the method of the generation of the e-statement in logic and step format.

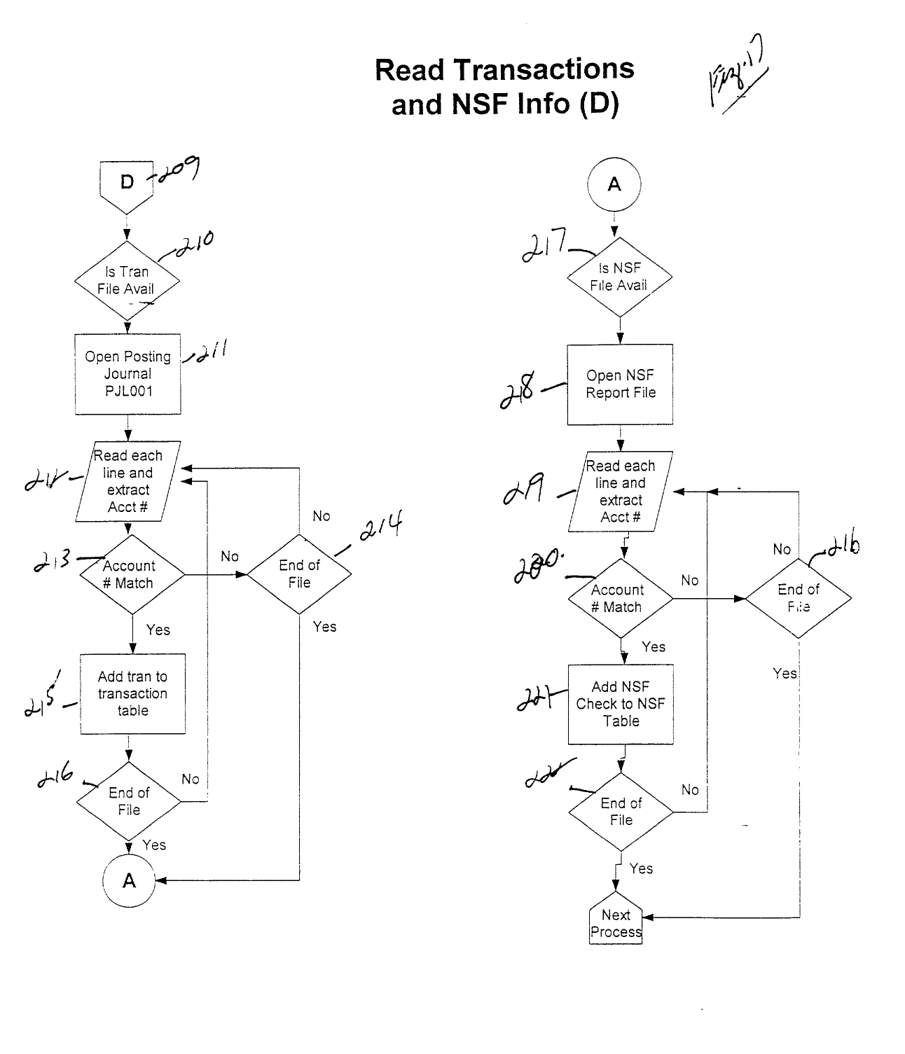

FIG. 14 is a view similar to FIG. 13 illustrating the sub-program of “make statements”.

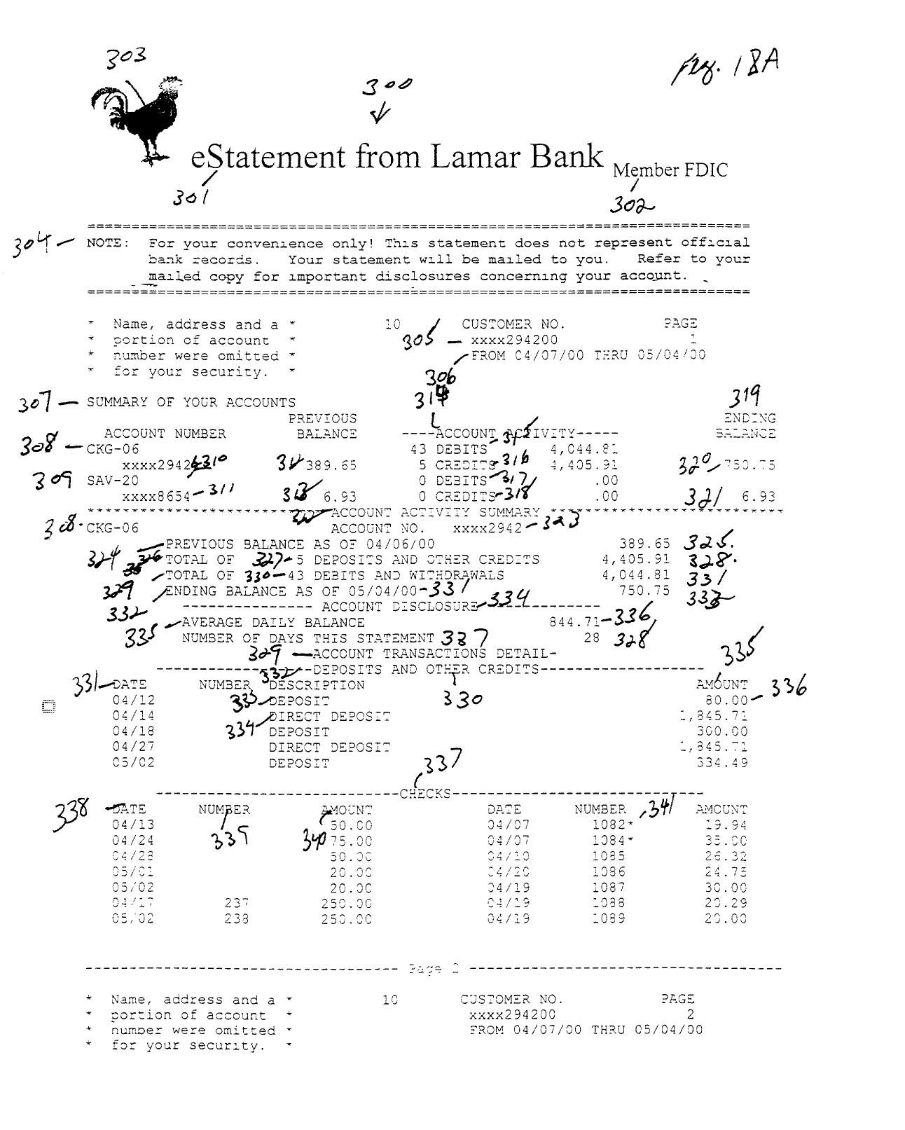

FIG. 15 is a view similar to FIGS. 13 and 14 showing another sub-program pertaining to reading of the loans files.

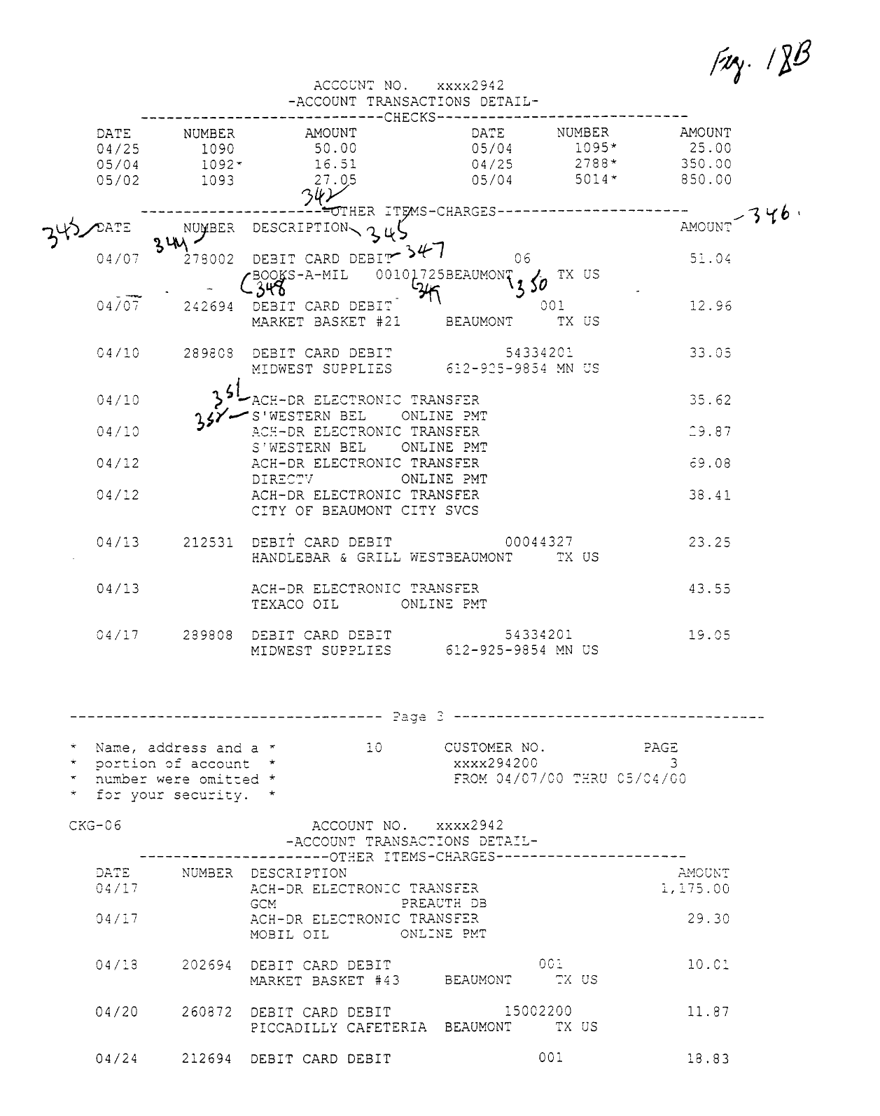

FIG. 16 is a view similar to FIGS. 13 through 15 showing the logic and step path for the reading of deposit trial balances files.

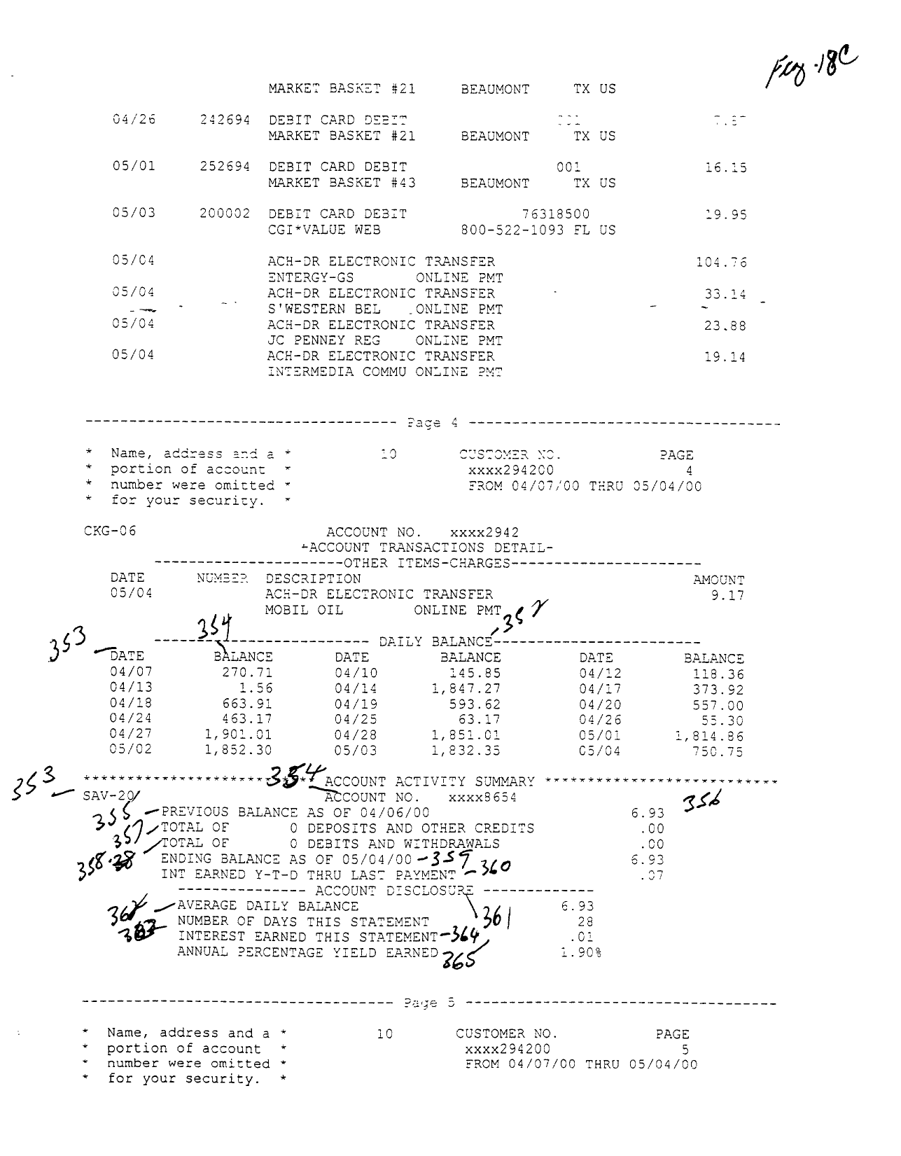

FIG. 17 is yet another logic/step view similar to FIGS. 13 through 16 of the sub-program of reading transactions and NSF (non-sufficient funds) files.

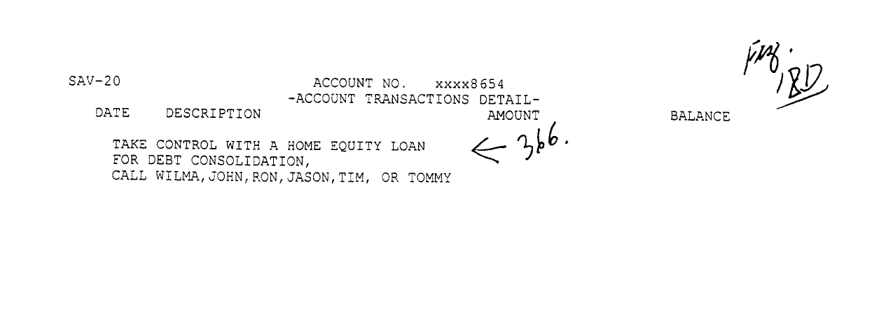

FIGS. 18A through 18D together constitute an illustration of a representative printout of a detailed statement generated in accordance with the present invention, and as built from data input as illustrated in FIGS. 2 through 12 in accordance with the description in the specification relating thereto.

### DESCRIPTION OF THE PREFERRED EMBODIMENTS

Now with reference to FIG. 1, there is shown a sample of an e-statement preferred format 1 which is transmitted electronically from the financial source, through a computer via conventional e-mail Internet services.

The statement 1 may appear upon a computer screen, or the like, and/or may be printed out in any tangible format. As shown, the e-statement 1 contains a first line 2 containing the title and the source of the statement and any advertising or promotional or legal notice requirements, such as “Member FDIC”. A date line 3 is provided for specifying the statement generation date and time of generation. As shown, the statement 1 has a statement generation field 3 specifying that it is generated “as of close of business Monday Oct. 16, 2000”. A salutation/description line 4 brings the attention of the reader to the subject matter of the e-statement 1.

Fields 5, 6 and 7 are clustered on one line to identify the type of account, and the digitized account number 6, which may have one or more sub-fields in “x”ed or other disguising configuration, for security purposes. Field 7, as shown, describes the account as “Household Account”.

Below the field lines 5, 6 and 7 are found the Available Balance field 8 and the Exact Balance field 9 as of the date of the generation of the e-statement 1, reflected in field 3.

A field 10 is identified as “Last Deposit”, giving the amount field 11 in numbers, and an “as of” or “on” field 12 for identifying the date of the last deposit 10 which may or may not, be the same date as the generation date 3 of the e-statement 1.

Field 13 specifies the transactions for the account identified in field 6 by date 14, serial or transaction number 15, amount 16 and transaction source and type 17. As shown, under the date field 14, three transactions, 18, 19 and 20 are shown for Oct. 16, 2000 with each being identified by a separate serial number 15. Each of the amounts 16 for the transactions 18, 19 and 20 are identified and described in the transaction identification field 17, such as a check, ACH, debit or a VISA® banking creditor debit card, well known to those skilled in the art.

The e-statement 1 also has a similar information in fields for another account 22 which is identified in field 1 as a “savings account” and further identified in description field 23 as a “Household Savings Account”. An available balance field 24 similar to that in field 8 is shown for the savings account 21 in a specific monetary amount at field 25. A last deposit field 26 indicates, as shown, an amount of $2,000 in field 27 deposited to the account on Oct. 13, 2000 as shown in field 28.

Again, particular transactions for the account are shown in field 26 with the account being respecified in field 27. The transactions are identified along field line 29 by date, field 30, serial number, field 31, amount, field 32 and transaction source and type, field 33. The date is provided in field 34 with the serial number identification field 35 and the specified amount of the transaction in the amount field 36. In field 37, the transaction is identified as a “withdrawal”, the amount of $40.00, field 36.

The e-statement 1 may be provided in a number of formats, with FIG. 1 being only representative of an arrangement of the accumulation of the financial data in the statement format 1.

The operation of the e-statement method and program will now be described. FIGS. 2 through 12 illustrate various computer generated video screen or CRT displays of various menu selections incorporated within a preferred program for the e-statement process. As shown, and as previously described, the program is preferably generated through the computer by means of a WINDOWS® computer operating system which is well known and generally publically available in numerous versions.

With first reference to FIG. 2, a main menu 38 is displayed. The main menu has sub-menus identified as customers 39, options 40, verify files 41, enable auto e-mail 42, generate e-mail 43, broadcast 44 and general help fields or sub-menus 45 and exit field 46.

The customer's menu or field 39 is more particularized in FIG. 3 and discussed hereafter in detail. In this customer's field 39, a customer's name, e-mail address and account information are entered or changed, from time to time.

The main menu 38 also contains an option field 40 for the purpose of changing certain program options such as the directory path to reports, default fonts and graphics for statements, auto e-mail settings, and to define core processor transaction codes, and the like.

The verify files field 41 assures verification that all files which are needed to generate a current days e-statements have been downloaded from the financial source core computer processor.

The enable auto e-mail field 42 is used to turn on or off any program feature monitoring the progress of the daily report downloads from the financial organization's core computer processor. Additionally, this field 42 generates e-statements as soon as all required reports have been received and processed just prior to generation of the e-statement configuration to the customer.

The generate e-mail field 43 is utilized to generate a current days, week's or months e-statements which may be prepared and sent on any incremental time basis. This field 43 is a manual request field. The program itself verifies to confirm that all required report files are available. However, if some required reports are not available or are incomplete, the program allows the user the option to continue or abort the request through activation of the generate e-mail field 43 as shown and described in more detail in FIG. 9 and discussion relating thereto.

The broadcast field 44 is utilized to send an e-mail message to all or a selected group of customers receiving e-statements to announce changes, delays, modifications, or any other material information which is desired to be generated and transmitted to a select number of customers.

The help menu selection field 45 is conventional in nature and is provided for purposes of immediate computer program operating assistance.

Finally, the exit program or field 46 maybe utilized for click-on to return to the original WINDOWS® desktop configuration after termination of entry into the program.

Now with particular reference to FIG. 3, the customer's sub-program or field 39 in the main menu 38 will now be described. As shown in FIG. 3, the customer's field 39 is shown in spreadsheet configuration. Fields 50 through 54 are entered in negative/zero configuration where the negative is reflective of a “true” state and a “0” is indicative of a false state, as further described below. Sub-fields 47 through 55 are displayed across the spreadsheet in a horizontal configuration. The “Id” field permits entry of a unique number or code correlated to a single customer. Within the customer name field 48 are listed the individual customer names, by individual or business. The e-mail address field is horizontally displayed adjacent the customer name field 48 which is followed by fields 50-54 for a specific service information. For example, “CHRG” field 50 is a field indicating whether or not the customer is to be charged for the service of providing the e-statement. A negative number in this field 50 would indicate that the customer is to be charged for the e-mail statement service. The “CONF” field 51 is utilized to verify that the customer has returned the confirmation of the e-mail address. The “SUSP” field 52 is utilized to indicate possible temporary or permanent suspension of the service for this particular customer. The “No Ad” field 53 is utilized to indicate whether or not electronic advertising is to accompany the e-statement with transmission to this particular customer. The “Rate” field 54 is utilized to indicate the transmission of various interest rates being paid to customers on deposit accounts or charged to customer on loan accounts by the bank.

The “Add/Edit” button 56 is a click field which will allow the program user to add a new customer, to delete a customer, or change any of the information about the customer in any of the fields 47 through 55. Selecting this button 56 with a customer's information highlighted will display that customer's information for editing purposes. Selecting this button without a customer's information highlighted will display the first customer's information for editing purposes, or , alternatively, the last customer's information for such purposes, as described below. The “Close” button 57 will, of course, return the program to the main menu display, as in FIG. 2.

The Add/Edit button 56 window display is particularized in FIG. 4. Fields 47 through 54 are displayed vertically and correspond to the horizontal configuration for such fields in FIG. 3. The address name field 48 may be filled in by a click-on and type in of the data in field 48A. Likewise, the e-mail address field 49 may be clicked on to insert such information in field 49A. As indicated, charge and confirmed fields 50 and 51 are positively indicated by click-on at fields 58 and 59. Fields 60, 61 and 62 likewise are that they are click-checked or the field left blank, as the case requires. The sort name field 63 is filled in at corresponding field 64 by use of first, last or code names, as required. The Add button 65 is conventional and clears all the fields and sets them to their default value thus allowing the entry of a new customer's information, or update of such information. Likewise, the delete button 66 deletes the displayed customer from the field. When the delete button 66 is utilized, no additional e-statement will be generated for that particular customer. The update button 67 is utilized to update the customer's information with the contents displayed on the screen, FIG. 3, FIG. 4, or adds a new customer to the database after the information has been entered. The Account button 68 allows the program user to add or edit account information for the customer currently being displayed. The Close button 69 closes the window display FIG. 4 to return to the display format of FIG. 3.

Now with reference to FIG. 5, there is shown the statement account display which allows the program user to add or edit account information for the customer currently being displayed in particular fields. The Account field 70 is entered in space 71 in alpha numeric format from the financial systems main computer processing unit. This number is assigned at the time the account is opened, such as a purchase of a certificate of deposit, or completion of a loan transaction. A limited number of digits for the account number field 71 are permitted to be displayed on the e-statement or account attachments as illustrated in FIG. 1, for security purposes. The reference number field 72 is entered in space 73 from the financial organization's main computer and this number may, or may not, be the same as the account number 71, depending upon the particular operations of the bank's central computer processing system. However, the number in the field 73 is never displayed or printed on the e-mail statements or account statement attachment due to a computer block for printout of this particular number, also for security purposes.

The account name field 74 is filled in at space 75 as it will appear on the customer's e-statement, as in FIG. 1. This can be any name which is meaningful to the customer. For security reasons it should not be the customer's actual account name and preferably will be, as reflected in the e-statement of FIG. 1, identified as “Household Account” or “Regular Checking”, or the like. The customer will be able to identify the respective accounts by the last four digits of the account number, as printed, and not particularly with reference to the specific name in the field 75. The account type field 76 is entered at 77 by scrolling on button 78 for one of a number of account types reported on the program, such as checking, savings, certificate of deposit, commercial loan, consumer loan, line of credit, revolving account, or the like.

The reports balance field 79 is checked in the adjacent area if the balance of the account is to be reported each day, week, month, or the like, along with certain other information specific to each account type.

The scroll down button 78 may be clicked on to select one of a number of account type 76 in field 77, such as checking accounts, savings accounts, loans, certificates of deposits, and the like.

If the report balance field 79 is checked in the appropriate location, supplemental information for the various types of accounts as indicated in the field 77 will be generated and included within the e-statement. For example, if checking accounts is scrolled into the field 77 by click-on to the arrow button 78, current balance, available balance, date of last deposit, amount of last deposit, posted transactions and NSF (None Sufficient Funds) Items will be generated. If “Loans” is scrolled into the field 77, current balance, interest rate, payment amount, last payment due, next due date, maturity date, payoff balance, interest year-to-year and collateral description information will also be generated. If savings accounts is scrolled into the field 77, available balance, date last deposit, amount of last deposit and posted transactions will be generated into the e-statement automatically. If certificates of deposit are entered into the field 77, current balance, next payment date and accrued interest information will be generated.

If the report transactions field 80 is checked, all transactions posted to the account will be listed in the e-statement along with other information, as described above.

If the report NSF field 81 is checked, any debit, such as a check, or the like, presented for payment when the account does not have sufficient funds to pay the debit will be reported, so that the customer may make provision for supplemental or immediate deposits, or the like or transfer of other funds into the account. NSF Items appear before any other account information on the e-statements as an alert courtesy to the customer. This option is, of course, valid for only checking accounts or accounts similar to conventional checking accounts.

The attached statement field 82 is checked if it is desired for any statement produced for the account by the bank's core processing computer system to be added to the e-statement as an attachment. Integrated statements, i.e., those with more than one account on a single statement, may be attached only once, if desired. The extract ASCII field 83 is checked if it is desired to generate an ASCII text file each day that there are transactions for an account and attached to that day's e-statement. This file can be imported into many different accounting programs for account reconciliation operations, as desired.

The extract Qwicken™ field 84 is checked if a file in Qwicken™ format is to be created each day there are transactions for an account and attached to that days e-statement for transmission to the customer. This file can be imported into Qwicken™ for account reconciliation. The report on given days, such as Monday through Fridays fields 85 through 89 are checked for generation of e-statement for that particular day. For example, the customer may only want certificate of deposit or loan information on a weekly basis since these accounts customarily have limited transactions, whereas checking accounts may have transactions on them several times each day. In such case, a report may be generated for each day of the week by checking in the appropriate fields 85 through 89. Alternatively, field 90 may be checked if a report is to be generated only on a monthly basis and field 91 is completed to indicate on the day of such month that the e-statement is to be generated and transmitted to the customer.

Field 98 is the “Last Statement” field and appears at the upper right hand corner of the window. This field is the date of the last statement generated for the account and is utilized for information purposes only. Add, delete, update and previous and next buttons 92 through 96 are provided for respective adding, deleting, updating, or moving to previous and next displays, in conventional format. Likewise, the Close button 97 is provided to close the window and return to the previous format.

FIG. 6 represents the visual configuration of the program appearing on the CRT or other screen from the main menu selection of options 40. FIG. 6 is illustrated with the change report path and change loan data path submenu options preparing in the window. These options allow the program user to designate the full path name to the directory where the computer download financial report files from the core computer are downloaded at the end of each day, the like. As shown on FIG. 6, the correct report download directory may be selected by either clicking on to a location field 106 or by entry of the file name 99 in field 100 or by scrolling at 107 for designation in the field 104 of the files of type 103 and then clicking to the open button 101. The selection may be cancelled by clicking at 102 prior to opening the file at 101. Opening the file 101 will change the path to the files in the windows registry. The report path and the loan data path typically will be identical.

As shown in FIG. 7, another submenu option is the “change system information” option. This submenu option permits the program user to change some of the program options, as provided. The system name field 108 will permit entry at location 109 of the brand name used for the title of the statement, such as “E-Statement”. Other service mark titles may be utilized as desired. The name which is entered and placed in the field 109 will be used on all customer e-mail that is generated.

The bank name field 110 identifies the supplier of the service at 111 and is entered in the e-statement in the “from” field (see FIG. 1). The statement font size 112 is entered in space 113 which will be the font size used in the account statements created as attachments.

The statement graphic field 114 is inserted at 115 if a valid graphic file name is to be entered and the graphic will be added to the upper left hand corner of the statement attachments, to include a logo, or the like in the e-statement configuration transmitted to the customer. The brouse button 116 is used to select reference to a graphic file, which may be created as needed. The save button 117 may be used to save the currently displayed program settings and close the window to return to the main menu. Likewise, the close button 118 will close the window and return to the main menu without saving any changes.

As shown in FIG. 8, another submenu option is the “Edit Auto E-Mail Settings”. This submenu option will allow the program user to change the time to begin the e-statement generation each day, and a number of minutes between attempts to automatically generate e-statement through the computers and the internet to receipt by the customer, if all reports needed are not available at the time of initial desired generation.

The “begin e-mail” function 120 time is entered in space 121 by scrolling up or down on buttons 122, 123. This time is the time that the computer is instructed to begin trying to generate and send the days e-statement. The minutes between attempts field 124 is selected and entered at 125 by scroll up or down at buttons 126 and 127 to reflect the time in between attempts to try to generate such e-statement because downloads from a core data processing system may take several minutes or even hours. If all of the reports are not completely downloaded, continual repetitious checks for the reports may not be successful. Therefore, by increasing the time between checks, a computer processing usage can be limited and e-statement may be generated in a reasonable time after the last report is received.

Save and cancel button 128 and 129 are utilized to either save the currently displayed program setting and close the window and return to the main menu or to close the window and return to the main menu without saving such information.

The program contemplates and enable/disable submenu option, which is used only during testing. Disabling users will check the “Suspend” option for each e-statement customer except the customer whose customer ID is a specific number, such as “10”. This will allow the program user to test new program settings, while sending e-statements to only one customer, such as a staff member of the financial organization. Selecting “enable” will return all customer's to their previous suspended status.

The next submenu option is illustrated in FIG. 9 and provides the set up and screen profile for the generation of the selected e-statement. This submenu option allows the user to generate the selected portions of the daily e-statements generated by the financial organization main computer as well as to attach a personal message. This submenu may be used to send information of a special nature that may not have been available at the time that the e-statements were generated on a daily, weekly or other basis. Fields 130 through 135 may be checked by appropriate click for balance information, transactions, loan information, statement attachments, CSV attachments or Qwicken™ attachments. Field 136 may be used for personal messages. After completion of this option, the continue button is click at 37 or the operation may be cancelled by clicking at 138.

FIG. 10 illustrates another submenu option generally referred to as “edit tran codes”. This submenu allows the operator to provide descriptions used in the e-statement for the different type of transactions posted to deposit and/or loan accounts. A transaction code field 139 is typed in in area 140 and corresponds to a pre-determined code in the computer for a given transaction type and is assigned by the main data processor. A description field 140 is used for insertion of an identification if the title of the transaction code, such as “new account opening deposit” at area 141. A debit field 142 may be checked at location 143 to indicate that the transaction code is for a debit transaction, such as a check or an ACH debit for insurance, car payment or the like. The add button 144 clears the content of all the fields and resets them to their default value enabling the program user to enter a new transaction code, when desired. Likewise, the delete button 145 will delete the information for the currently displayed transaction code. The refresh button 146 is used to realign all the transaction codes in numerical order. This button may be used after a new transaction code has been entered to get it in the proper numeric sequence for viewing. The update code 147 is used to update information with the contents displayed on the screen or may be used to add a new transaction code to the database after the transaction code's information has been entered.

The close button 148 will close the window and return to the previous screen. Arrow keys 149 and 150 will function as “next” and “previous” buttons for displaying or scrolling from one transaction code to the next as reflected in field 151.

Now returning to referred FIG. 2, the verify files field 41 is used to verify that all necessary files are available to produce the days e-statements. Each of these files is given a specific code and they're contained within the main or core computer system. Typically, and preferably, these files will include the following:

1. Daily checking account mini-trial balance.

2. Daily savings account mini-trial balance.

3. Daily certificate of deposit account mini-trial balance.

4. Daily loan account mini-trial balance.

5. Daily discount loan trial balance.

6. Daily simple interest loan trial balance.

7. Daily customer's without account trial balance.

8. Daily posting journal containing all posted transactions for all account types in account number order.

9. Daily posting journal containing posted transactions for all account types in amount order.

10. Daily file containing all statements printed the previous.

11. A laser notice file.

12. The daily NSF checks notices in officer order (including copy).

If all the files are not present in the downloaded director, a message to that affect will be displayed on the screen. If they are not, a message showing each missing file is displayed as it is check. Several of the files listed above are not used for information but the presence of the file indicates completion of certain downloading steps.

FIG. 11 is a main menu selection display for enablement and disablement of automatic e-mail generation. This function eliminates a need for a program user to remember to generate thee-statement each day at a certain time. When the program is running and auto e-mail is enable, the program monitors the time of day. When the selected time is reached, such as reflected in the next schedule field 152 reflected in area 153, it checks to see if all reports needed have been downloaded. If they have, the program generates the daily e-statements and waits another 24 hours, or other time designed period, before repeating the operation. If not, the program will repeat checking every few minutes or other time increments until all the files have been downloaded. During the waiting phase, the display is as shown in FIG. 11. The last complete field 150 shows a date and time in the area 151 for the last completed cycle. The next schedule field 152 is completed in area 153 to show beginning of the next cycle for the generation of the e-statements. The last attempt field 154 will automatically reflect in area 155 a “complete” or “waiting” indicator. The missing files area 156 will automatically reflect in location 157 the number or identification of files that are missing and are required for the complete generation of the e-mail statement. Finally, current time in field 158 is reflected in area 159.

FIG. 12 reflects the view on the screen of the main menu selection for “broadcast”. The broadcast field is identified as “send to” at 160 and a list of selected classification of users, such as “all paying users” may be reflected and selected in area 161 by scrolling on 162. The subject of the broadcast is identified at field 163 in area 164, such as “monthly charges”. A message describing the subject is reflected in the field 164 may be manually inserted in a message are 165 and sent to the selected grouping of customers designated in 161 by clicking on the send 166. Alternatively, the message and the broadcast maybe cancelled by clicking at 167 which will return the user to the main menu.

The software preferably utilized to implement the present invention may be any one of a comparatively low level machine code, such as visual basic. The logic and sub-routines utilized to form the e-statement method disclosed in FIGS. 1 through 14 is set forth below:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

The preferred method may also be described with reference to the process steps as set forth in FIGS. 13 through 17. Now, with first reference to FIG. 13, there is displayed the various steps in logical sequence from the beginning of e-statement generation up to the actual building of the e-statements. The statement generation step 168 is initiated by verifying input of the various files described above, for extraction of certain financial data, such as balances, debits and credits to checking accounts, loan accounts and the like, previously described and for ultimate display into the e-statement as shown in FIG. 1. During final verification step 169, a negative response will block continued processing and return to menu reflected in block 170.

If all files are positively verified at 169, all variables are initialized in step 171. The variables initiated in step 171 then are loaded into a format in step 172 and dimension variables 173 are configured. If it is then desired to process the statements at step 174, the functions are run and the statements are made at 175.

The actual creation step 176 for the statements is illustrated in FIG. 14. For the making of the statements 176, the dimension variables 173 are considered and the various source files are searched to confirm their presents at step 177. If the files are not present, step 178, return to run function 175 to step 169. If step 177 confirms the presents of various files, the files are open and the header lines are read as step 179. The lines are then read until the top of the page is identified, step 180. The first 8 lines are read and the account number is extracted at step 181 to confirm account number match up step 182. If the confirmation cannot be made at step 182, step 180 is repeated until confirmation is established. Confirmation of account number through step 182 permits continuance of makeup of the statements and an HTML file is built by reading each line of the statement, step 183. The file creation then is ended, step 184 or steps 180 through 183 repeated until creation of the file. Creation of the file enables return step 185 to process balances in the selected accounts (files) step 186. As part of the processing of the balances 186, the loan files are accessed and processed for balances and the like at 187. The loans are read as a sub-step 188.

The loan sub-step 188 is initiated 189 to process, as shown in FIG. 1, two loan files, trial balances 190. Each line of the text from the files is conducted at 191 and extraction of selected character lines, such as 2 through 11 for purposes of FIG. 1 is effected through step 192. If the characters are numeric, 193 an account number match is effected 194. If the characters are not numeric, 193, steps 191 and 192 are repeated to search for any information which can be utilized to effect an account match-up. If the account number match-up is effected, 194, the balance table is updated with data from 3 file lines, for example, to effect the configuration for FIG. 1 at step 195. The file is now complete, 196 or steps 191 through 195 are repeated until the file is completed and return to main program, 197.

After the return step 197, the trial balances for deposit accounts are read and the balance information is extracted, step 198. If the account does not reflect any active loans, step 188 is not initiated and the deposit trial balances readings is immediately effected.

The deposit trial balances step 198 will now be described. First, old balances from the data base for all accounts are deleted as step 199. Confirmation of the existence of such files is then made at 200. If no files are present, trial balances for deposits sub-step 198 is not effected. If presence of the files is confirmed at 200, the files are processed, for example, 3 as shown in FIG. 1, incrementally at 201. Each file is opened in sequence at 202 and each line is read to find and extract the account number, 203. The account number match-up is either confirmed or not at step 204 and, if not, step 203 is repeated until confirmation of the account number match-up. The balance table is updated at step 205 and the file creation is completed, 206, or steps 203, 204 and 205 are repeated until completion of the file and return to transaction processing, step 207. The processing is continued through step 208 by reading all transactions and non-sufficient funds information sub-step d 209.

The reading of the transactions and NSF information, sub-step 209 is as shown in FIG. 17. The availability of the transactions file is confirmed at 210 and a posting journal is opened, step 211. Each line is read and the account number is extracted, step 212 and an account number match is confirmed 213. If the account number cannot be matched positively, the file is terminated at step 214 or procedure 212 repeated until confirmation is established 213. If the file is terminated at step 214, the run function is continued, step 175 and the statements of processed at 174. If the account number is confirmed at 213, the transaction is added to the transaction table step 215 and creation of the file is terminated, 216, or steps 212, 213 and 215 repeated until file completion. File completion enables run function and statement processing steps 175 and 174, respectively, to be effected. Upon completion of the file 216, the availability of a non-sufficient fund file is checked at step 217 and the NSF report file is opened 218. Each line is read and the account number is extracted 219 with account number match up effected at 220. If there is no match-up, the file is terminated as step 216, or step 219 completed to effect an account match-up. After account match-up, 220, NSF checks are added to the NSF table for generation in the e-statement at step 221 and the file is completed, 222 and the statements are created and processed, steps 175 and 174. The e-statements are built as generally shown in FIGS. 2 through 12.

FIGS. 17A through 17D illustrate the configuration and orientation of an e-statement printout 300. With particular reference to FIG. 17A, the title block 301 is provided at the upper-most portion of the page with advertising or other special title trailer 302, provided adjacent the title 301. A logo 303 or other artistic embellishment is presented as field 303. A special notice 304 or disclaimer is provided just prior to printout of further specific information. A special printout of the customer number 305 deletes some of the digits to make the customer number incomplete, but is sufficient for the customer to know and identify his account number through his own personal knowledge.

Field 306 designates a time period for coverage of the information within the statement 300. A summary field 307 then is provided which basically summarizes and identifies the various accounts, such as checking 308 and savings 309, also with only partial complete digits of the account numbers for security purposes, 310 and 311. Respective balances 312 and 313 are provided for the accounts. An account activity field 314 serves to identify various debits and credits 315, 316, 317 and 318 for the associated accounts. The summary 307 also includes an ending balance column 319 for printing of the respective ending balances 320 and 321 for the respective accounts 308, 309.

More detail is provided in the statement 300 through a breakout of each of the account numbers identified in the summary 307. As shown, the first account activity summary 322 is for checking account “06”,308. The account number configuration is repeated in field 323 with the previous balance field 324 being used to identify the previous date of information summary and the previous balances identified at 325. A deposit total line 326 is given to identify the number 327 of deposits or other credits and a digitized 325 total of such deposits and other credits provided at 328. Likewise, a debit and withdrawal line 329 provides the total 330 of debits and other withdrawals and a digitized column reflecting such total. Finally, an ending balance 332 includes a field 333 for referencing the date of the ending balance and digitized field 332 for printing out the amount of such ending balance. General summary information for the checking account 308 is provided below line 334. As shown, the account disclosure field 334 may include an identification of average daily balance 335 in numerical format 336 and the total number od days for the statement cycle 337 and indicated as “28” in field 328.

Details of account transactions are identified at 329, such as deposits and other credits 330 identified in a date column 331 together with a description 332 such as deposit 333 or direct deposit 334 or other means. An amount column 335 is provided with digitized amounts identified, such as 336.

Checks are identified in the area 337 by date, columns 338, number 339 and amount 340. A star or asterisk 341 indicates numerical sequence has been broken.

As shown in FIG. 17B, the check transactions are continued and there below various miscellaneous charges of the bank or commercial organization are indicated at 342 by date 343, reference number 344, description 345 and amount 346. These charges may be reflected as a debit card actual debit 347 from a business identified as 348 using a business designation code 349 and physical location 350. Electronic transfers for automatic payment of utilities may be made, such as at 351 to a supplier 352.

A daily balance field 352 is provided for the checking account 308 with a breakdown by date 353 and balance 354, as shown in FIGS. 17C.

Also shown in FIG. 17C is a breakdown for another account, in this case, a savings account identified at 353 with a digitized account identifier at 354 with the first 4 digits therein deleted for security purposes. A previous balance line 355 provides the previous balance as of a given date, such as 356, together with total number of deposits or other credits 357 and total of debits and withdrawals 358 and ending balance line is provided 359 and, there below, a field for identifying and calculating the interest earned on a year to date basis through the last payment 360.

General account disclosure information is identified at title 361 which includes an average daily balance disclosure 362, the number of days in the statement cycle 363. Interest earned during the current statement period is provided at 364 together with the annual percentage yield as calculated in a percentage format at 365. Finally, the general promotional information or advertising is provided at the end of the statement in a general field identified as 366.

Although the invention has been described in terms of specified embodiments which are set forth in detail, it should be understood that this is by illustration only and that the invention is not necessarily limited thereto, since alternative embodiments and operating techniques will become apparent to those skilled in the art in view of the disclosure. Accordingly, modifications are contemplated which can be made without departing from the spirit of the described invention.

What is claimed and desired to be secured by Letters Patent is:

1) A method incorporating a financial institution computer system for extracting financial data within a data base in the computer system, formatting the data and transmitting the formatted data via electronic mail comprising the steps of:
(a) maintaining electronic information on financial accounts of a customer within said data base in the financial institution computer system;
(b) processing said electronic information within the data base to identify and extract pre-selected data therefrom;
(c) electronically formatting said data for transmission to said customer via electronic mail; and
(d) transmitting the formatted data to a location designated by said customer via electronic mail for storage within and readout on a computer system of said customer.

2) The method of claim 1, wherein the step of maintaining electronic information includes the sub-step of creating and maintaining at least one of the following electronic file formats and sortable by individual customer identification code:
(1) checking;
(2) savings;
(3) certificate of deposit;
(4) loan;
(5) discount loan;
(6) simple interest loan;
(7) customer's without account;
(8) posting journal for containing all posted transactions for all account types in account number order;
(9) posting journal for posting transactions for all account types in amount order;
(10) previously transmitted statements file;
(11) laser notice file; and
(12) non-sufficient fund check notice files in officer order.

3) The method of claim 2, wherein the step of processing said electronic information includes the sub-steps of generating and creating at least one of the following file formats on a predeterminable time increment basis:
(1) mini trial balance for each checking account;
(2) mini trial balance for each savings account;
(3) mini trial balance for each certificate of deposit account;
(4) mini trial balance for each loan account;
(5) mini trial balance for each discount loan account;
(6) trial balance for each simple interest loan account;
(7) trial balance for each customer's without account;
(8) all posted transactions for all account types in account numerical order;
(9) posted transactions for all account types in amount order;
(10) all statements printed for a previous statement transmission period;
(11) a notice in laser format; and
(12) all NSF checks in officer order.

4) The method of claim 1 wherein the step of electronically formatting said data includes the sub-step of creating within the financial institution computer system a main menu for said data including submenu selections for customers, options, verify files, enable auto e-mail, generate e-mail, broadcast, help and exit.

5) The method of claim 1 wherein said step of electronically formatting said data for transmission to said customer includes the sub-step of creating within said financial institution computer system a main menu selection of customers to whom the formatted data is to be transmitted.

6) The method of claim 5, further including the sub-step of generating an identification symbol in numerical format for each said customer and including entry of an e-mail address for each such identified customer.

7) The method of claim 4 further comprising the sub-step of including within the customer menu an indicator of charge/no charge to the customer for transmission of said formatted data.

8) The method of claim 4 further comprising the sub-step of including within the customer menu an indicator of confirmation/no confirmation by the customer of the e-mail address indicated in said customer menu.

9) The method of claim 4 further comprising the sub-step of actuating means indicated in the customer main menu for suspending formatted data transmissions to a customer.

10) The method of claim 4 further comprising the sub-step of activating means prohibiting advertising being sent in the data transmission to the customer.

11) The method of claim 4 further comprising the sub-step of activating means for generating an interest rate calculation in an attachment to the customer with the data transmission on a pre-determined time basis.

12) The method of claim 4 further comprising the sub-step of activating the add/edit field in the customer main menu whereby at least one of the following fields are completed or changed:
(1) customer name;
(2) e-mail address;
(3) charge designation;
(4) confirmation of e-mail address by customer;
(5) suspend e-mail transmission;
(6) advertisement transmission block;
(7) transmission of interest rates on designated accounts; and
(8) name of customer by sort designation.

13) The method of claim 1 wherein the step of processing said electronic information includes the sub-step of generating a customer set up configuration by sorting the data field for each customer identification data reflected in at least one of the following fields:
(1) account number;
(2) reference number;
(3) account name;
(4) account type;
(5) balance for designated account;
(6) transactions for designated account;
(7) non-sufficient funds designation; and
(8) day or date for report transmission.

14) The method of claim 1 wherein the step of processing said electronic information includes the sub-step of enabling a statement automatic set-up mode to generate separate, individual processing attempts, spaced apart by time designations subsequent to a real time selection for initiating the processing step.

15) The method of claim 1 wherein the step of electronically formatting said data includes the sub-step of electronically generating at least one of the following financial data:
(1) account balance;
(2) account transactions;
(3) loan data;
(4) statement attachments;
(5) CSV attachments; and
(6) Qwicken attachments.

16) The method of claim 1 wherein the step of processing said electronic information includes the sub-step of verifying availability and access to designated files within the electronic information required for formatting said data for transmission to said customer.

17) The method of claim 1 wherein the step of formatting said data for transmission includes the sub-step of providing in broadcast mode to each customer a manually generated message for inclusion in and transmission of the formatted data.

18) A system for notifying a customer of financial information, comprising:
(a) a computer system including a data base including information on customer financial accounts and wherein the financial accounts are maintained in a financial institution computer program; and
(b) program logic implemented in the financial institution computer program comprising:
(1) means for maintaining electronic information within said program on the financial accounts;
(2) means for processing said electronic information to identify and extract the preselected data therefrom; and
(3) means for electronically formatting said data for transmission to said customer via electronic mail; and
(4) means for transmitting the formatted data to a location designated by a customer via electronic mail for storage within and readout on a customer computer system.

19) The system of claim 18 wherein the program logic further includes means for creating and maintaining at least one of the following electronic file formats sortable by individual customer identification code.
(1) checking;
(2) savings;
(3) certificate of deposit;
(4) loan;
(5) discount loan;
(6) simple interest loan;
(7) customer's without account;
(8) posting journal for containing all posted transactions for all account types in account number order;
(9) posting journal for posting transactions for all account types in amount order;
(10) previously transmitted statements file;
(11) laser notice file; and
(12) non-sufficient fund check notice files in officer order.

20) The system of claim 18 wherein the means for processing said electronic information includes means for generating and creating at least one of the following file formats on a predeterminable time increment basis:
(1) mini trial balance for each checking account;
(2) mini trial balance for each savings account;
(3) mini trial balance for each certificate of deposit account;
(4) mini trial balance for each loan account;
(5) mini trial balance for each discount loan account;
(6) trial balance for each simple interest loan account;
(7) trial balance for each customer's without account;
(8) all posted transactions for all account types in account numerical order;
(9) posted transactions for all account types in amount order;
(10) all statements printed for a previous statement transmission period;
(11) a notice in laser format; and
(12) all NSF checks in officer order.

21) The system of claim 18 wherein the means for electronically formatting said data includes means for creating within the financial institution computer program a main menu for said data including sub-menu selections for customers, options, verify files, enable auto e-mail, generate e-mail, broadcast, help and exit.

22) The system of claim 18 wherein the means for electronically formatting said data further includes means for creating within the said financial institution computer program a main menu selection of customers to whom the formatted data is to be transmitted.

23) The system of claim 18 wherein the program logic further includes means for generating an identification symbol in numerical format for each said customer and including entry of an e-mail address for each such identified customer.

24) The system of claim 18 wherein the program logic further includes means for indicating a charge or no charge to the customer for transmission of said formatted data.

25) The system of claim 18 wherein said program logic further includes means for receipt of electronic confirmation by the customer of the e-mail address indicated by the customer.

26) The system of claim 18 further including program logic including means for suspending formatted data transmissions to a customer.

27) The system of claim 18 wherein the program logic further includes means for prohibiting the electronic transmission to the customer of advertising with the formatted data.

28) The system of claim 18 wherein the program logic further includes means for generating an interest rate calculation in an attachment to the customer with the data transmission on a pre-determined time basis.

29) The system of claim 18 (the program logic further includes means for activating an add/edit field in a customer main menu whereby at least one of the following fields may be completed or changed:
(1) customer name;
(2) e-mail address;
(3) charge designation;
(4) confirmation of e-mail address by customer;
(5) suspend e-mail transmission;
(6) advertisement transmission block;
(7) transmission of interest rates on designated accounts; and
(8) name of customer by sort designation.

30) The system of claim 18 wherein the program logic further includes means for sorting data for each customer reflected in at least one of the following fields:
(1) account number;
(2) reference number;
(3) account name;
(4) account type;
(5) balance for designated account;
(6) transactions for designated account;
(7) non-sufficient funds designation; and
(8) day or date for report transmission.

31) The system of claim 18 wherein the program logic further includes means for enabling a statement automatic set up mode to generate separate, individual processing attempts, spaced apart by time designations subsequent to a real time selection for initiating the process step.

32) The system of claim 18 wherein the program logic further includes means for generating at least one of the following financial data:
(1) account balance;
(2) account transactions;
(3) loan data;
(4) statement attachments;
(5) CSV attachments; and
(6) Qwicken attachments.

33) The system of claim 18 wherein the program logic further includes means for verifying availability and access to designated files within the computer system required for formatting said data for transmission to said computer.

34) The system of claim 18 wherein the program logic includes means for providing in broadcast mode to each customer a manually generated message for inclusion in and transmission of the formatted data.

35) An article of manufacture for use in programming a financial institution computer system maintaining a data base including information on a plurality of customer accounts, the article of manufacture comprising a computer useable storage medium having at least one computer program stored therein that causes a financial institution computer system to perform steps of:
(a) maintaining electronic information in the financial institution computer system on financial accounts;
(b) processing said electronic information to identify and abstract preselected data therefrom;
(c) electronically formatting said data for transmission to said customer via electronic mail; and
(d) transmitting the formatted data to a location designated by a customer via electronic mail for storage within and readout on a customer computer system.

36) The article manufacture of claim 35 wherein the step of maintaining electronic information includes as sub-step of creating and maintaining at least one of the following electronic file formats sortable by individual customer identification code:
(1) checking;
(2) savings;
(3) certificate of deposit;
(4) loan;
(5) discount loan;
(6) simple interest loan;
(7) customers without account;
(8) posting journal for containing all posted transactions for all account types in account number order;
(9) posting journal for posting transactions for all account types in amount order;
(10) previously transmitted statements file;
(11) laser notice file; and
(12) non-sufficient fund check notice files in officer order.

37) The article manufacture of claim 35 wherein the step of processing said electronic information includes as sub-step of generating and creating at least one of the following file formats on a pre-determinable time increment basis:
(1) mini trial balance for each checking account;
(2) mini trial balance for each savings account;
(3) mini trial balance for each certificate of deposit account;
(4) mini trial balance for each loan account;
(5) mini trial balance for each discount loan account;
(6) trial balance for each simple interest loan account;
(7) trial balance for each customer's without account;
(8) all posted transactions for all account types in account numerical order;
(9) posted transactions for all account types in amount order;
(10) all statements printed for a previous statement transmission period;
(11) a notice in laser format; and
(12) all NSF checks in officer order.

38) The article manufacture of claim 35 wherein the step of electronically formatting said data includes the sub-step of creating within the financial institution computer system a main menu for said data including sub-menu selections for customers, options, verify files, enable auto e-mail, generate e-mail, broadcast, help and exit.

39) The article manufacture of claim 35 wherein the step of electronically formatting said data for transmission to said customer includes the sub-step of creating within said financial institution computer system a main menu selection of customers to whom the formatted data is to be transmitted.

40) The article of manufacture of claim 35 further including the sub-step of generating an identification symbol in numerical format for each said customer and including entry of an e-mail address for each identified customer.

41) The article of manufacture of claim 35 further comprising the sub-step of including within the customer menu an indicator of charge/no-charge to the customer for transmission of said formatted data.

42) The article of manufacture of claim 35 further comprising the sub-step of including an indicator of confirmation/no confirmation by the customer of the e-mail address indicated in the program logic.

43) The article of manufacture of claim 35 further comprising the step of activating means indicated in the program logic for suspending formatted data transmissions to a client.

44) The article of manufacture of claim 35 further comprising the step of activating means prohibiting advertising being sent in the data transmission to the customer.

45) The article of manufacture of claim 35 further comprising the step of activating means for generating and interest rate calculation in an attachment to the customer with the data transmission on a pre-determined time basis.

46) The article of manufacture of claim 35 further comprising the step of activating an add/edit field in the program logic whereby at least one of the following fields are completed or changed:
(1) customer name;
(2) e-mail address;
(3) charge designation;
(4) confirmation of e-mail address by customer;
(5) suspend e-mail transmission;
(6) advertisement transmission block;
(7) transmission of interest rates on designated accounts; and
(8) name of customer by sort designation.

47) The article of manufacture of claim 35 further comprising the step of generating a customer set up configuration by sorting a data field for each customer identification data reflected in at least one of the following fields:
(1) account number;
(2) reference number;
(3) account name;
(4) account type;
(5) balance for designated account;
(6) transactions for designated account;
(7) non-sufficient funds designation; and
(8) day or date for report transmission.

48) The article of manufacture of claim 35 wherein the step of electronically formatting the data includes the step of electronically generating at least of the following financial data:
(1) account balance;
(2) account transactions;
(3) loan data;
(4) statement attachments;
(5) CSV attachments; and
(6) Qwicken attachments.

49) The article of manufacture of claim 35 further including the step of processing the electronic information and enabling a statement automatic set-up mode to generate separate, individual processing attempts, spaced apart by time designations subsequent to a real time selection for initiating the processing step.

50) The article of manufacture of claim 35 wherein at least one of the following financial data files is sourced and data extracted therefrom:
(1) account balance;
(2) account transactions;
(3) loan data;
(4) statement attachments;
(5) CSV attachments; and
(6) Qwicken attachments.

51) The article of manufacture of claim 35 wherein the step of processing includes the sub-step of verifying availability and access to designated files within the electronic information required for formatting the data for transmission to the customer.

52) The article of manufacture of claim 35 wherein the step of formatting the data for transmission includes the sub-step of providing in broadcast mode to each customer a manually generated message for inclusion in and transmission of the formatted data.
